(19) United States
(12) Patent Application Publication
(10) Pub. No.: US 2005/0144422 A1
(43) Pub. Date: Jun. 30, 2005

(54) Virtual to physical address translation

(76) Inventors: Gary L. McAlpine, Banks, OR (US); Dave B. Minturn, Hillsboro, OR (US); Greg J. Regnier, Portland, OR (US); Frank L. Berry, North Plains, OR (US)

Correspondence Address: FISH & RICHARDSON, PC, 12390 EL CAMINO REAL, SAN DIEGO, CA, 92130-2081, US

(21) Appl. No.: 10/750,567

(22) Filed: Dec. 30, 2003

(51) Int. Cl. G06F 12/08

(52) U.S. Cl. 711/206

(57) ABSTRACT

A virtual to physical address translator in which a requesting process supplements a virtual memory address with a shortcut to a physical address associated with one level of a multi-level virtual address translation table. A second process, such as an I/O process, receives the shortcut and the virtual address and uses an address translator to determine the physical address. In some implementations, the shortcut may be made opaque to the requesting process such that the requesting process cannot determine the physical address represented in the shortcut.

### BACKGROUND

Virtual memory allows programmers to use a larger range of memory for programs and data than the physical memory available to the CPU. The computer system maps a program's virtual addresses to real hardware storage addresses (i.e., a physical address) using address translation hardware. Conventional address translation hardware is capable of translating virtual addresses of programs and data within the virtual address space of the program executing, but does not support translation of virtual addresses in other virtual memory spaces by the program currently executing.

### DESCRIPTION OF DRAWINGS

FIG. 1 is a diagram of a server having a main CPU and two Packet Processing Engines.

FIG. 2 is a diagram of a server having a main CPU and a Packet Processing Engine.

FIG. 3 is a diagram of a virtual interface between two processes executing on two different processors.

FIG. 4 is a diagram of a page table structure.

FIG. 5 is a flow chart of a buffer registration process.

FIG. 6 is a flow chart of a data transfer process.

### DETAILED DESCRIPTION

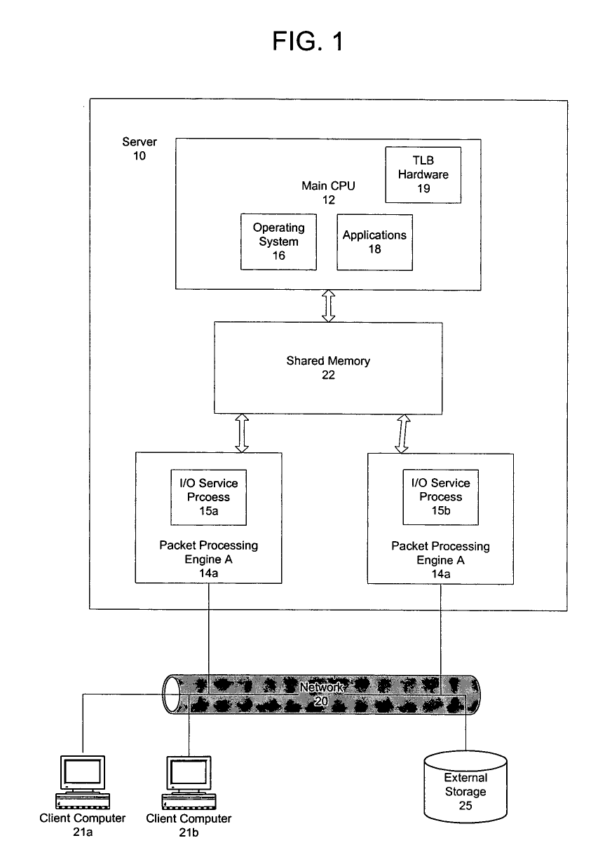

Referring to FIG. 1, a server 10 includes a host central processing unit (CPU) 12 and one or more packet processing engines (PPE), for example Packet Processing Engines 14a, 14b. The Packet Processing Engines process communication traffic between the server 10 and client computers 21a, 21b or other external systems such as storage device 25 over a network 20.

The processing load of server 10 is partitioned between the host CPU 12 and Packet Processing Engines 14a, 14b. In particular, the host CPU 10 executes an operating system 16 of the host and various application programs 18, while the Packet Processing Engines 14a, 14b each execute, in parallel with host CPU 10, input/output (I/O) service processes 15a, 15b, for the operating system 16 and applications 18. The Embedded Transport Acceleration (ETA) architecture by Intel Corporation described in Regnier, Greg et. al., “ETA: Experience with an Intel Xeon Processor as a Packet Processing Engine”, Hot Interconnects 11, 2003, is an example of an architecture in which processing load is partitioned between application/operating system processing and network packet processing.

Host CPU 12 multiplexes execution of multiple applications 18 and the operating system 16 with each running in a different virtual memory address space. The operating system 16 and I/O service processes 15a, 15b execute in kernel virtual memory space and the applications 18 each execute in separate user virtual memory spaces. The processors (e.g. host CPU and packet processors) each include address translation hardware, e.g., Translation Look-Aside Buffer (TLB) hardware 19, that enables them to translate virtual addresses in program instruction to the actual physical addresses in order execute memory references to the appropriate locations in shared physical memory.

While conventional TLB hardware is capable of translating virtual addresses for programs and data within the virtual address space of the program as it executes, it typically does not support translation of virtual addresses in other virtual memory spaces by the program currently executing. In addition, only programs executing in kernel virtual memory space have the ability to access the address translation tables and reference physical addresses. Hence, a program executing in user space can only utilize or generate virtual addresses as references to data structures and buffers.

Any specialized kernel mode process written to provide a service directly to a user mode program and manipulate data structures or buffers in the user mode program's virtual space must be able to translate virtual addresses from the user mode program's virtual space to the corresponding physical addresses in memory. An example of such a process is I/O service processes 15a, 15b shown in FIG. 1, which provide direct I/O packet processing services for one or more user mode programs. One way I/O service processes 15a, 15b may use to translate virtual addresses of a user mode program is to make calls to the operating system to have the operating system perform the translation and pass the translated addresses back to the I/O service process. This method, however, can be expensive in terms of CPU cycles and slow in terms of latency. Another method involves the provision of an additional address translator on a processor (e.g. host CPU or packet processor) that enables the processor to translate virtual addresses in any virtual address space to the corresponding physical addresses, without the current program executing in the virtual space of the virtual addresses being translated.

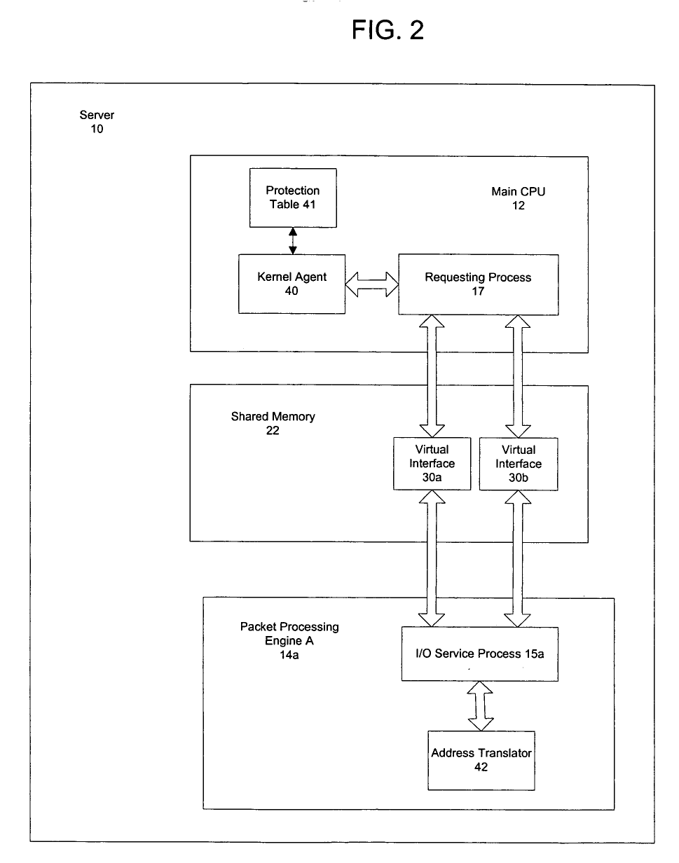

Referring to FIG. 2, the host processor (e.g. main CPU 12) maintains a Kernel Agent 40 and the Packet Processing Engine 14a maintains an address translator 42. While this implementation describes an address translator 42 for a packet processor 14a, any processor providing services within a virtual memory operating environment may include such an address translator. A Requesting Process 17 running on the host CPU 12 interfaces with the I/O Service Process through one or more asynchronous Virtual Interfaces, for example Virtual Interfaces 30a, 30b, stored in the server's Shared Memory 22.

The Kernel Agent uses calls to the host operating system to associate virtual addresses in any virtual space with the corresponding physical pages. The I/O Service Process 15a uses the Address Translator 42 to associate virtual addresses in any virtual space with the corresponding physical pages. The Kernel Agent 40 and I/O service process 15a are each driver-level processes that execute in kernel virtual memory space. In one implementation, the Address Translator 42 is a hardware state machine. However, other implementations may implement the address translator as software or a combination of software with hardware acceleration.

The Kernel Agent 40 and Address Translator 42 provide a mechanism for the I/O service process 15a to determine the corresponding physical address of any virtual address within the virtual space of the requesting process 17 (e.g., an application program or the operating system). The I/O Service Process 15a also maintains a protection table (not shown) that enables it to enforce protections between requesting processes and/or between virtual interfaces. The I/O service process uses this table to limit the virtual address ranges each virtual interface or process is allowed to access and the types of accesses it is allowed to perform via I/O operations. The protection table may also be utilized for limiting the ranges of addresses an external system (such as storage system 25 shown in FIG. 1) is allowed to access via remote direct memory access (RDMA) transactions.

A requesting process 17 (e.g., an application program or the operating system) executing on the main CPU 12 interfaces with I/O service process 15a through the shared memory 22 of the server 10 via one or more asynchronous virtual interfaces 30a, 30b.

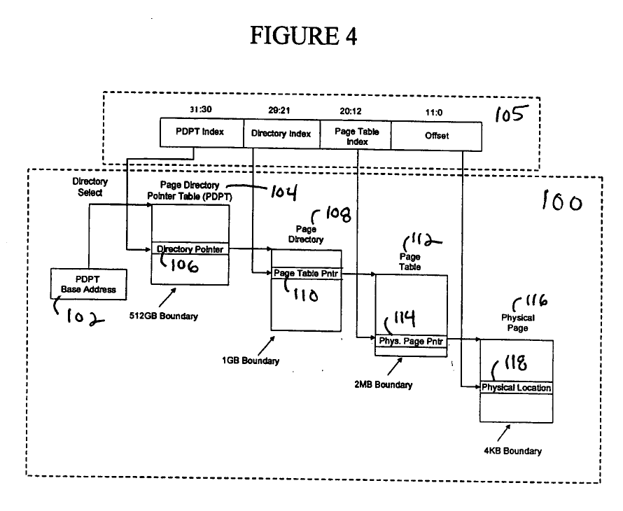

Virtual interface 30a, 30b is created by Kernel Agent 40 at the request of an application process. The virtual interface 30a, 30b is created in the virtual memory space of the application (e.g. requesting) process. When a virtual interface is created, a corresponding context file is created in kernel virtual memory space. The context file is private to the I/O service process 15a and the kernel agent process 40 executing in the main CPU (both shown in FIG. 2). The context file includes the root address of the address translation table that maps the virtual address space of the application (e.g., the Page Directory Pointer Table base address shown in FIG. 4) and a shortcut key, which may be unique to the requesting process 17 or the specific virtual interface 30a, 30b. The shortcut key enables the kernel agent 40 to encrypt shortcut values and enables address translator 42 to de-encrypt shortcut values encrypted by the kernel agent. The Kernel Agent 40 may also maintain a protection table 41 that associates protection keys with memory ranges authorized by the protection keys. The protection keys enable the I/O service process 15a to access the protection table for the purpose of ensuring requested I/O transfers are authorized to access the virtual memory space specified by the I/O requests.

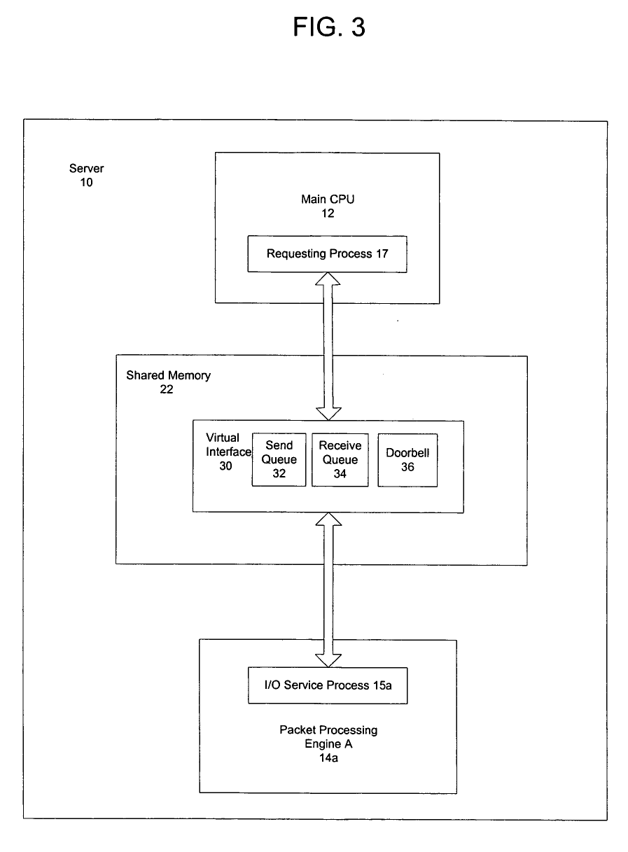

Referring to FIG. 3, each virtual interface 30 includes a send queue 32, receive queue 34, and a doorbell 36. A requesting process 17 makes input/output requests to the I/O service process 15a running on a Packet Processing Engine 14 using a virtual interface 30. For example, if an application needs to send data across the network to a process running on a client computer 21 or other external system such as storage system 25, it places a request into the virtual interface send queue 32 to send data. The request includes the virtual address of the head of the data buffer to be sent, a shortcut to the translation table entry for the virtual address, and the size of the data to be sent. In some implementations, I/O requests may also include a protection key. The application rings the doorbell of the virtual interface to notify one of the I/O service processes that an I/O request is pending. The doorbell also provides the I/O service process with the virtual address of the request in the send queue 32.

Because applications typically execute in user virtual memory space and thus only reference virtual addresses, an application that passes an I/O request to a Packet Processing Engine via a virtual interface specifies the location of the data buffer by virtual address. This requires the I/O service process 17 executing in the Packet Processing Engine 14a to translate the buffer and queue addresses into their corresponding physical addresses.

FIG. 4 illustrates the translation of a virtual address 105 from a requesting process (e.g., an application process) through a multi-level virtual address translation table 100 for a 32-bit Intel Architecture (IA32) environment. In this particular implementation, the virtual address space of the process has a root pointer 102, which points to the base address of the Page Directory Pointer Table (PDPT) 104. The PDPT for IA32 has four 64-bit entries and is indexed by the most significant 2 bits of the virtual address 105. A system with a virtual address 105 greater than 32 bits would support a PDPT with greater than 4 entries. Each entry in the PDPT includes a pointer 106 to the base physical address of a page directory 108.

Each page directory, e.g., page directory 108, includes up to 512 64-bit entries and is indexed by bits 29:21 of the virtual address 105. Each entry in the page directory includes a pointer 110 to the base physical address of a page table 112.

Each page table, e.g., page table 112, includes up to 512 64-bit entries and is indexed by bits 20:12 of the virtual address 105. Each page table entry, if valid, includes a pointer 114 to the base physical address of a physical page 116 and various other status and control bits.

Each physical page, e.g., physical page 116, is a block of contiguous memory (in this case a 4 KB block). The least significant 12 bits of the virtual address 105 provides a byte offset into the physical page to the physical location 118 being referenced. Thus, combining all but the low 12 bits of the physical page pointer 114 with the low 12 bits of the virtual address 105 produces the physical address. Physical addresses may be greater than 32 bits in length.

The page table structure illustrated in FIG. 4 accommodates a virtual address space of 4 GB per process and assumes a 4 KB page size. (Up to 512 GB per virtual spaces may be supported with a virtual address with 39 or more bits and 4 KB pages. Greater than 512 GB per virtual space may be supported with a page size greater than 4 KB and a virtual address greater than 39 bits.) Each process (e.g., an application process) uses its own virtual address space. When the main CPU executes a program that references a virtual address, it determines the PDPT base address of the process and may perform as many as three memory accesses to obtain the directory pointer, page table pointer and the page table entry in order to assemble the physical address of the data.

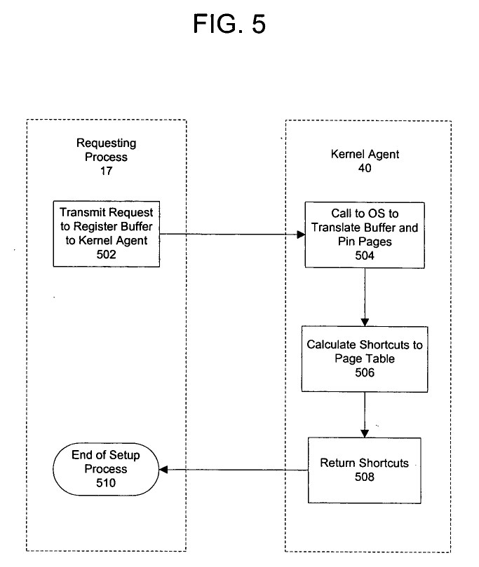

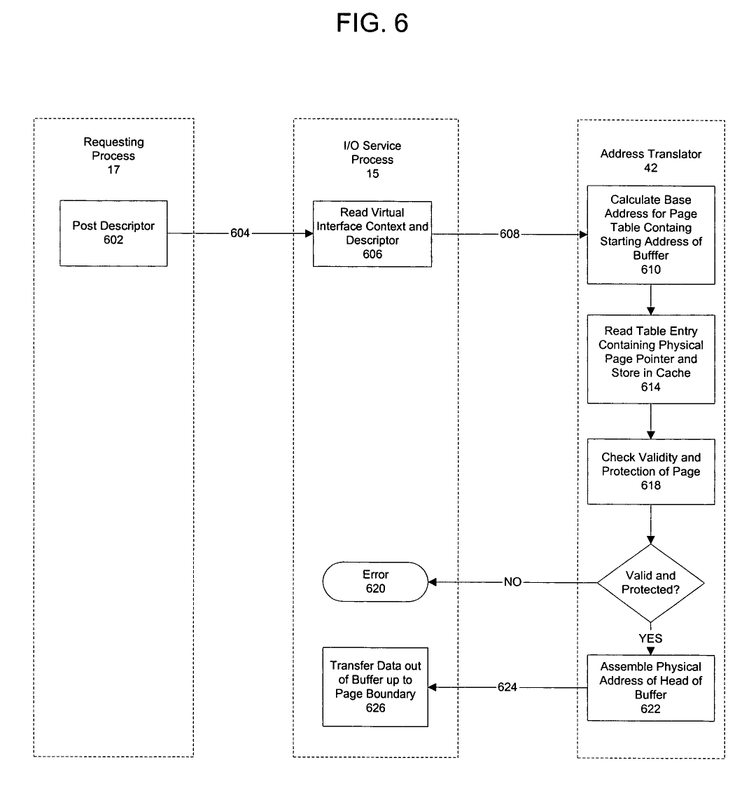

FIGS. 5-6 illustrate a requesting process (e.g., an application program) making an I/O request to a Packet Processing Engine that uses the page table structure shown in FIG. 4. However, the address translation mechanism may be applied in any environment in which processes are assigned non-contiguous virtual address space and is not limited to the particular virtual memory structure illustrated in FIG. 4.

As shown in FIG. 5, a requesting process initially registers the buffer containing the data that the requesting process seeks to input or output. The requesting process 17 sends 502 a request to the Kernel Agent to register a virtual buffer. The buffer registration request includes the virtual address of the beginning of the buffer and the length of the buffer.

When the Kernel Agent receives a request to register a buffer, it uses calls to the host operating system to translate the virtual memory location of the beginning of the buffer and the buffer size into the corresponding physical page addresses. The Kernel Agent also requests that the operating system pin the virtual pages into the physical pages of the buffer space to ensure the buffer will be present in physical memory during any subsequent I/O operations. For example, if the application wants to transfer data to or from a 3 MB buffer beginning at virtual address “VA1”, it requests the kernel agent to register the buffer “VA1”, the Kernel Agent makes one or more calls to the operating system to translate “VA1” into its physical memory address location “PA1”, which may be located within a page mapped by page table “A”. Because the buffer is greater than 2 MB, the associated set of physical page pointers will necessarily extend across at least a second page table (e.g., page table “B”). Thus, the Kernel Agent also requests that the operating system pin the associated physical memory pages beginning at the page for “PA1” in page table “A” and extending through the physical page pointer entries in page table “B” encompassing the 3 MB of the buffer.

After receiving the corresponding physical pages from the operating system, the Kernel Agent generates 506 shortcuts to each of the page tables that map the buffer and passes them back to the requesting application. Thus, in the above example, the Kernel Agent would generate shortcuts to page tables “A” and “B”, the page tables that map the buffer. In one implementation, a shortcut may simply be the physical address of the particular page table. Thus, when the application passes an I/O request descriptor to an I/O service process, the service process is able to directly address the physical page pointer using the shortcut in combination with page table index field (i.e., bits 20:12) of the virtual address. This enables the I/O service process to obtain the physical location of the address using only one memory access. In a preferred implementation, the shortcut is made opaque to the application process in order to prevent the application process from determining physical addresses of the server's shared memory. The shortcut may be made opaque to the application by applying a function “F” to the page table pointer and the shortcut key contained in a context file associated with the requesting process 17 or the associated virtual interface 30. As explained above, the context file is a private file shared between the Kernel Agent 40 and the I/O service process 15a. Additionally, the Kernel Agent may apply different functions and different keys to encrypt the shortcuts associated with different requesting processes 17 or different virtual interfaces 30. For example, in one embodiment, the Kernel Agent may apply a shortcut function “F1” and key “K1” to generate shortcuts for one requesting processes and apply function “F1” and key “K2” to generate shortcuts for another requesting process and so on. In another embodiment, the kernel agent may apply a function “F2” and a key “K1” to generate shortcuts for one virtual interface and a function “F2” and a key “K2” to generate shortcuts for another virtual interface and so on. In an implementation employing functions and keys to encrypt shortcuts, an I/O service process 15a and a kernel agent 40 will have a mutual understanding of which functions to apply and which keys to apply through contexts stored in shared memory 22.

In response to the buffer registration request from the requesting process, the Kernel Agent returns 508 the shortcuts to the requesting process and completes 510 the buffer registration process.

After the requesting process 17 receives the shortcuts from the Kernel Agent 40, the requesting process 17 can make I/O requests that access the buffer via virtual interfaces according to the transfer process 600 shown in FIG. 6.

Referring to FIG. 6, the application process posts 602 a send or receive descriptor (e.g. I/O request) on the send or receive queue of a virtual interface. This descriptor includes the virtual address of the referenced buffer, the corresponding shortcut from the list of shortcuts provided by the Kernel Agent, and the size of the buffer being posted. In another implementation, the descriptor also includes a protection key. The requesting process uses bits 20:12 of the virtual address to select the corresponding shortcut to the page table 112 from the shortcut list.

The requesting process 17 notifies 604 the I/O service process 15 via the virtual interface doorbell that one or more descriptors have been posted in a send or receive queue.

When the descriptor gets to the head of the send or receive queue, the I/O service process reads 606 the descriptor to obtain the shortcut and virtual address of the head of the buffer to be transferred. The I/O service process also reads the context information associated with the virtual interface to obtain the shortcut key.

The I/O service process 15 provides 608 the key, the virtual address and the shortcut to the address translator 42. The address translator decrypts the shortcut by applying the inverse of the function used by the Kernel Agent to generate the shortcut and the secret key shared between the Kernel Agent 40 and address translator 42. From these parameters, the address translator calculates 610 the base physical address for the page table that covers the range of virtual addresses that includes the starting address of the I/O transfer. The address translator uses the table index field (i.e., bits 20:12) of the virtual address to read 614 the table entry containing the physical page pointer for the starting address of the buffer. This read also causes a cache-line of table entries to be stored in a cache of the Packet Processing Engine. Thus, subsequent address translations may not require any memory accesses to retrieve the physical page pointer.

While translating an address, the Address Translator 42, also checks 618 the validity and protections of the set of pages involved in the associated I/O transfer and whether or not the pages are pinned into physical memory. The Address Translator 42 checks the validity and protections of the pages by consulting the protection table 41 maintained by the Kernel Agent 40 (shown in FIG. 2). It determines whether the pages are valid and pinned by checking status bits in each page table entry. If the Address Translator 42 determines that the buffer is not valid, the requesting process or associated virtual interface is not authorized access that space, or the pages are not all pinned into physical memory, it returns 620 an error to the I/O service process. If the Address Translator 42 determines that the pages are valid and pinned and the access is authorized, it assembles 622 the physical address of the head of the buffer (by combining the offset in bits 11:0 of the virtual address with the physical page pointer) and hands 624 the physical address back to the I/O service process. The I/O service process uses the physical address to effect the transfer 626 of data into or out of the buffer by, e.g., a direct memory access, up to the page boundary.

If the buffer extends beyond a page boundary, the I/O service process makes a series calls (630 and 640) to the address translator to get the base physical address of each subsequent page involved in the transfer. Alternatively, the address translator may be configured to accept with one call the starting virtual address, size of a transfer, and each of the shortcuts and return a list including the starting physical address and the physical page pointer to each subsequent page involved in the transfer.

Other embodiments are within the scope of the claims. For example, a Packet Processing Engine or I/O processor may be configured to control and maintain secure I/O operations in a virtual machine operating environment. In this scenario, the Packet Processing Engine would run the I/O drivers for all external I/O devices and use a private (trusted) DMA circuit to move data between I/O buffers and the buffers in each virtual machine. The Packet Processing Engine may use the address translation and protection mechanisms to protect virtual machine partitions from each other's I/O or externally controlled I/O (e.g. RDMA).

1. A machine-implemented method comprising:
receiving, by a first process, a shortcut to a physical address associated with a level of a multi-level virtual address translation table;
posting a descriptor comprising a virtual address and a shortcut to an interface between the first process and a second process; and
determining the physical address corresponding to the virtual address based on at least the virtual address and the shortcut.

2. The method of claim 1 further comprising transferring data to or from the buffer located at the physical address.

3. The method of claim 1 further comprising:
generating the shortcut by a third process.

4. The method of claim 3 wherein generating the shortcut by the third process comprises:
receiving a request to register a virtual buffer, the request including a virtual address corresponding to the start of the virtual buffer;
determining the physical address of one level of the multi-level address translation table associated with the virtual memory space in which the virtual buffer resides; and
generating a shortcut based on the physical address of the one level of the multi-level address translation table.

5. The method of claim 4 wherein generating a shortcut further comprises:
generating the shortcut based on a key unknown to the first process.

6. The method of claim 4 wherein generating a shortcut further comprises:
generating the shortcut based on a function unknown to the first process.

7. The method of claim 1 further comprising:
retrieving a key by the second process; and
applying the key to the shortcut to produce the physical address associated with one level of a multi-level virtual address translation table.

8. The method of claim 1 further comprising determining if the physical address is associated with the first address.

9. The method of claim 1 further comprising determining if the virtual page containing the virtual address is pinned into physical memory.

10. The method of claim 1 wherein the interface is a virtual interface.

11. The method of claim 1 further comprising determining if the first process is authorized to access the virtual address.

12. The method of claim 1 further comprising determining if descriptors posted to the interface between the first process and second process are authorized to access the virtual address.

13. The method of claim 1 further comprising:
receiving, by a first process, a plurality of shortcuts, each shortcut to a physical address associated with a level of a multi-level virtual address translation table.

14. The method of claim 4 wherein generating a shortcut comprises:
applying a function, F, to the physical address of the one level and a key.

15. The method of claim 14 wherein the key is associated with the interface between the first and second process.

16. The method of claim 14 wherein the key is associated with the first process.

17. A machine-implemented method comprising:
generating, by a first process, a request to register a virtual buffer mapped to physical memory by a multi-level virtual address translation table associated with the first process;
determining a block of memory that includes the physical address corresponding to the start of the virtual buffer; and
generating, by a second process, one or more shortcuts based on the block of memory including the physical address corresponding to the start of the virtual buffer.

18. The method of claim 17 wherein generating a shortcut further comprises:
generating the shortcut based on a key, which is unknown to the first process.

19. The method of claim 17 wherein generating a shortcut further comprises:
generating the shortcut based on a function, which is unknown to the first process.

20. The method of claim 17 further comprising:
transmitting a request to a third process to perform an input or output operation on the virtual buffer, wherein the request includes the shortcut and a virtual address associated with the virtual buffer; and
determining a physical address of the virtual address based on the virtual address and the shortcut.

21. The method of claim 20 further comprising:
determining if the physical address is associated with the first address; and
if the physical address is associated with the first address, then enabling the input or output operation on at least part of the virtual buffer.

22. The method of claim 20 further comprising:
determining if the associated physical pages are pinned into physical memory; and
if the associated virtual pages are pinned into physical memory, then enabling the input or output operation on at least part of the virtual buffer.

23. The method of claim 20 further comprising:
determining if the requesting process is authorized to access the associated virtual buffer; and
if the requesting process is authorized to access the associated virtual buffer, then enabling the input or output operation on at least part of the virtual buffer.

24. The method of claim 20 further comprising:
determining if requests posted to the interface between the first process and the third process are authorized to access the associated virtual buffer; and
if requests to the interface are authorized to access the associated virtual buffer, then enabling the input or output operation on at least part of the virtual buffer.

25. The method of claim 18 further comprising:
transmitting a request to a third process to perform an input or output operation on the virtual buffer, wherein the request includes one of the one or more shortcuts and a virtual address associated with the virtual buffer; and
determining a physical address of the virtual address based on the virtual address, the shortcut and the key.

26. A system comprising:
a first processor capable of:
executing instructions of a first process which causes the first processor to produce a shortcut to a physical address associated with a level of a multi-level virtual address translation table; and
executing instructions of a second process which causes the first processor to post a descriptor comprising a virtual address and the shortcut to an interface; and
a second processor capable of executing instructions of a third process which cause the second processor to:
read the descriptor posted on the interface; and
determine a physical address of the virtual address based on at least the virtual address and the shortcut.

27. The system of claim 26 wherein the instructions of the first process cause the first processor to encrypt the shortcut with a key.

28. The system of claim 27 wherein the instructions of the third process cause the second processor to:
retrieve the key; and
apply the key to the shortcut to produce the physical address associated with one level of a multi-level virtual address translation table.

29. The system of claim 28 wherein the instructions of the third process cause the second processor to determine if the physical address is associated with the second process.

30. The system of claim 28 wherein the instructions of the third process cause the second processor to determine if the associated virtual pages are pinned into physical memory.

31. The system of claim 28 wherein the instructions of the third process cause the second processor to determine if the second process is authorized access to the virtual buffer.

32. The system of claim 27 wherein the instructions of the third process cause the second processor to determine if requests posted to the interface between the second process and the third process are authorized access to the virtual buffer.

33. A computer program product residing on a computer readable medium having instructions stored thereon that, when executed by the processor, cause that processor to:
produce a shortcut to a physical address associated with a level of a multi-level virtual address translation table; and
write a descriptor comprising a virtual address and the shortcut to an interface.

34. The product of claim 33 having instructions that further cause the processor to encrypt the shortcut with a key.

35. The product of claim 33 having instructions that further cause the processor to encrypt the shortcut with a function.

36. A computer program product residing on a computer readable medium having instructions stored thereon that, when executed by the processor, cause that processor to:
read a message posted on an interface by a first process, the message including a shortcut to a physical address associated with a level of a multi-level virtual address translation table; and
determine a physical address of the virtual address based on at least the virtual address and the shortcut.

37. The product of claim 36 having instructions that further cause the processor to:
retrieve a key; and
apply the key to the shortcut to produce the physical address associated with one level of a multi-level virtual address translation table.

38. The product of claim 36 having instructions that further cause the processor to determine if the physical address is associated with the first process.

39. The product of claim 36 having instructions that further cause the processor to determine if the virtual pages referenced by the message are pinned in physical memory.

40. The product of claim 36 having instructions that further cause the processor to determine if the first process is authorized access to the virtual buffer referenced by the message.

41. The product of claim 36 having instructions that further cause the processor to determine if messages posted on the interface are authorized access to the virtual buffer.

42. A system comprising:
a client computer; and
a server in communication with the client computer using a network, the server comprising:
a first processor capable of producing a shortcut to a physical address associated with a level of a multi-level virtual address translation table and writing a descriptor comprising a virtual address and the shortcut to an interface; and
a second processor capable of reading the descriptor posted on the interface, determining a physical address of the virtual address based on at least the virtual address and the shortcut and transferring data located at the physical address to the client computer using the network.

43. The system of claim 42 wherein the first processor is capable of encrypting the shortcut with a key.

44. The system of claim 43 wherein second processor is capable of decrypting the shortcut to produce the physical address associated with one level of a multi-level virtual address translation table.

45. The system of claim 42 wherein the interface is a virtual interface.

46. A system comprising:
a storage device; and
a server in communication with the storage computer using a network, the server comprising:
a first processor capable of producing a shortcut to a physical address associated with a level of a multi-level virtual address translation table and writing a descriptor comprising a virtual address and the shortcut to an interface; and
a second processor capable of reading the descriptor posted on the interface, determining a physical address of the virtual address based on at least the virtual address and the shortcut and transferring data located at the physical address to the storage device using the network.

47. The system of claim 46 wherein the first processor is capable of encrypting the shortcut with a key.

48. The system of claim 47 wherein second processor is capable of decrypting the shortcut to produce the physical address associated with one level of a multi-level virtual address translation table.

49. The system of claim 46 wherein the interface is a virtual interface.
